(19) United States
(12) Patent Application Publication
(10) Pub. No.: US 2020/0204571 A1
(43) Pub. Date: Jun. 25, 2020

(54) MALWARE DETECTION IN NETWORK TRAFFIC TIME SERIES

(71) Applicant: Avast Software s.r.o., Praha (CZ)

(72) Inventors: Martin Neznal, Praha (CZ); Mikulás Zelinka, Praha (CZ)

(21) Appl. No.: 16/662,949

(22) Filed: Oct. 24, 2019

Related U.S. Application Data
(60) Provisional application No. 62/782,029, filed on Dec. 19, 2018.

(51) Int. Cl. H04L 29/06; G06N 3/08

(52) U.S. Cl. CPC H04L 63/1416; G06N 3/08; H04L 63/145

(57) ABSTRACT

A method of identifying anomalous traffic in a sequence of computer network traffic includes preprocessing the sequence of computer network traffic into a high-dimensional time series sequence of computer network traffic, and providing the high-dimensional time series to a recurrent neural network. The recurrent neural network evaluates the provided high-dimensional time series to generate and output a predicted next element in the high-dimensional time series, which is compared with an observed actual next element in the high-dimensional time series. The observed next element in the high-dimensional time series is determined to be anomalous if it sufficiently different from the predicted next element in the high-dimensional time series.

### CROSS-REFERENCE TO RELATED APPLICATION

This Application claims priority to U.S. Provisional Patent Application Ser. No. 62/782,029, filed on Dec. 19, 2018, entitled “MALWARE DETECTION IN NETWORK TRAFFIC TIME SERIES,” currently pending, the entire disclosure of which is incorporated herein by reference.

### FIELD

The invention relates generally to detection of malicious activity in computer systems, and more specifically to detection of malware in a network traffic time series.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

But, because the size of the Internet is so large and Internet users are so diverse in their interests, it is not uncommon for malicious users to attempt to communicate with other users' computers in a manner that poses a danger. For example, a hacker may attempt to log in to a corporate computer to steal, delete, or change information. Computer viruses or Trojan horse programs may be distributed to other computers or unknowingly downloaded such as through email, download links, or smartphone apps. Further, computer users within an organization such as a corporation may on occasion attempt to perform unauthorized network communications, such as running file sharing programs or transmitting corporate secrets from within the corporation's network to the Internet.

For these and other reasons, many computer systems employ a variety of safeguards designed to protect computer systems against certain threats. Firewalls are designed to restrict the types of communication that can occur over a network, antivirus programs are designed to prevent malicious code from being loaded or executed on a computer system, and malware detection programs are designed to detect remailers, keystroke loggers, and other software that is designed to perform undesired operations such as stealing information from a computer or using the computer for unintended purposes. Similarly, web site scanning tools are used to verify the security and integrity of a website, and to identify and fix potential vulnerabilities.

With new threats constantly emerging, efficient and timely detection of vulnerabilities within a computer network remain a significant challenge. It is therefore desirable to analyze network traffic in computerized systems to provide efficient detection of vulnerabilities.

### SUMMARY

One example embodiment of the invention comprises a method of identifying anomalous traffic in a sequence of computer network traffic, including preprocessing the sequence of computer network traffic into a high-dimensional time series sequence of computer network traffic and providing the high-dimensional time series to a recurrent neural network. The recurrent neural network evaluates the provided high-dimensional time series to generate and output a predicted next element in the high-dimensional time series, which is compared with an observed actual next element in the high-dimensional time series. The observed next element in the high-dimensional time series is determined to be anomalous if it sufficiently different from the predicted next element in the high-dimensional time series.

In a further example, the recurrent neural network is trained on windowed sequences from the sequence of computer network traffic, such as a multiple of a day, a week, or another period over which network data patters might reasonably be expected or observed to repeat.

In another example, the difference between the predicted next element in the high-dimensional time series and an observed actual next element in the high-dimensional time series comprise at least one of absolute difference, difference relative to either predicted or actual observed next element, z-score, dynamic threshold, or difference between short-term and long-term prediction error.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a computer network environment including a network traffic anomaly server operable to train a recurrent neural network to recognize network traffic anomalies and a firewall device operable to use the trained recurrent neural network to monitor network traffic for anomalies, consistent with an example embodiment.

FIG. 2 is a chart showing use of a trained recurrent neural network to identify network traffic anomalies, consistent with an example embodiment.

FIG. 3 shows a recurrent neural network, as may be used to practice some embodiments.

FIG. 4 is a chart showing preprocessed data sequences provided to the recurrent neural network, consistent with an example embodiment.

FIG. 5 shows how sequential input windows are used to train the recurrent neural network, consistent with an example embodiment.

FIG. 6 is a flowchart showing use of a trained recurrent neural network to detect network traffic anomalies, consistent with an example embodiment.

FIG. 7 is a graph showing prediction errors or loss L between recurrent neural network output and observed next network traffic values, consistent with an example embodiment.

FIG. 8 is a flowchart of a method of training a recurrent neural network to identify anomalies in network traffic, consistent with an example embodiment.

FIG. 9 is a flowchart of a method of using a trained recurrent neural network to identify anomalies in network traffic, consistent with an example embodiment.

FIG. 10 is a computerized network traffic anomaly system comprising a recurrent neural network training module, consistent with an example embodiment of the invention.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As networked computers and computerized devices become more ingrained into our daily lives, the value of the information they store, the data such as passwords and financial accounts they capture, and even their computing power becomes a tempting target for criminals. Hackers regularly attempt to log in to a corporate computer to steal, delete, or change information, or to encrypt the information and hold it for ransom via “ransomware.” Smartphone apps, Microsoft Word documents containing macros, Java applets, and other such common documents are all frequently infected with malware of various types, and users rely on tools such as antivirus software, firewalls, or other malware protection tools to protect their computerized devices from harm.

In a typical home computer or corporate environment, firewalls inspect and restrict the types of communication that can occur over a network, antivirus programs prevent known malicious code from being loaded or executed on a computer system, and malware detection programs detect known malicious code such as remailers, keystroke loggers, and other software that is designed to perform undesired operations such as stealing information from a computer or using the computer for unintended purposes. As new threats are constantly emerging, efficient and timely detection of vulnerabilities within a computer device such as a smartphone remain a significant challenge.

Some examples described herein therefore seek to improve network security by monitoring network traffic using a long short term memory (LSTM) model such as a recurrent neural network or convolutional neural network to monitor and characterize normal traffic, enabling the neural network to detect traffic patterns that are abnormal. In a more detailed example, a network traffic series is broken down into a time series of high-dimensional inputs, where the dimensions are features of the network traffic such as the number of specific network events per hour. These high-dimensional inputs are input to the LSTM neural network in windowed sequences, both to train the network and subsequently to evaluate network traffic for anomalies. In a more detailed example, network traffic features are compiled per hour, per day, or over other time periods during which traffic is observed to be similar.

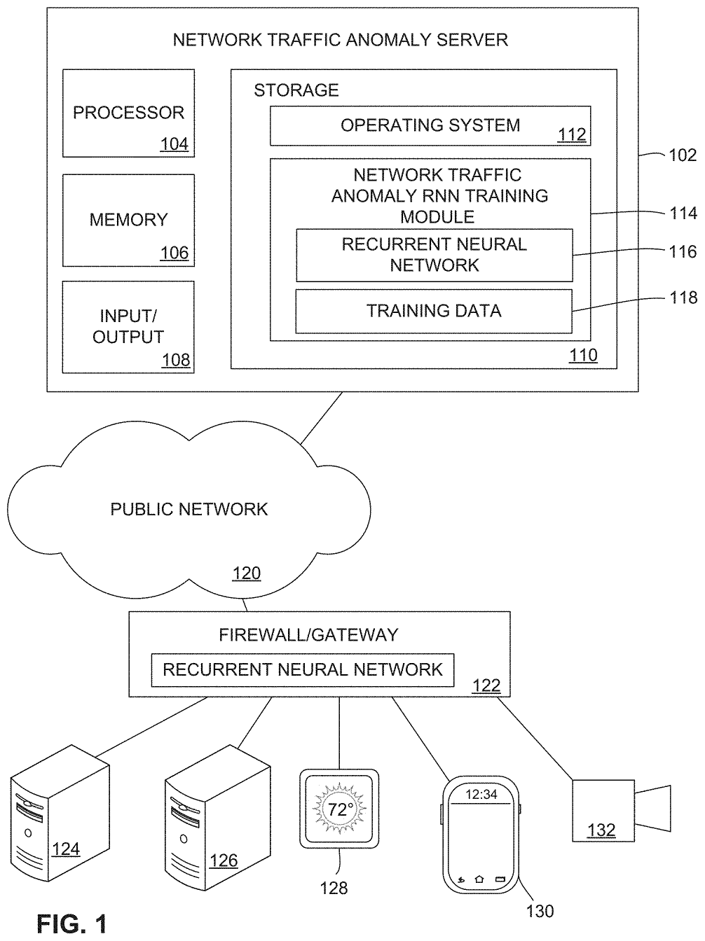

FIG. 1 shows a computer network environment including a network traffic anomaly server operable to train a recurrent neural network to recognize network traffic anomalies and a firewall device operable to use the trained recurrent neural network to monitor network traffic for anomalies. Here, a network traffic anomaly server 102 comprises a processor 104, memory 106, input/output elements 108, and storage 110. Storage 110 includes an operating system 112, and a network traffic anomaly training module 114 that is operable to train a recurrent neural network 116 using training data 119 to detect network traffic anomalies when installed in a network device such as firewall/gateway 122. The network traffic anomaly training module 114 is operable to train the recurrent neural network 116 such as by providing an expected output for a given sequence of input and backpropagating the difference between the actual output and the expected output using training data 118. The recurrent neural network trains by altering its configuration, such as multiplication coefficients used to produce an output from a given input to reduce or minimize the observed difference between the expected output and observed output. The training data 118 includes a variety of normal network traffic that can be used to train the recurrent neural network, and in a further example includes a variety of malicious traffic that can be used to help train the neural network to better identify anomalies or malicious traffic. Upon completion of initial training or completion of a training update, the recurrent neural network 116 is distributed such as via a public network 120 (such as the Internet, or a cellular network) to end user devices such as firewall/gateway 124.

In operation, a user such as a network administrator installs the recurrent neural network onto a computerized device such as firewall/gateway 122, such as by downloading and installing it as an application or selecting to run it as a service as part of the firewall/gateway's preconfigured software. Once installed and active, the recurrent neural network module on firewall/gateway 122 in this example is operable to scan network traffic between the connected devices 124-132 and the public network 120 for traffic that is atypical or anomalous.

In a more detailed example, the recurrent neural network module installed on firewall/gateway 122 is operable to scan network traffic before forwarding it to devices connected to the local area network, such as computers 124 and 126, smart thermostat 128, smartphone 130, and IP camera 132. If the recurrent neural network module determines that the network data is anomalous or is likely malicious, it notifies the user, stops forwarding the anomalous network traffic to the local area network, or performs other such functions to restrict transmission of the anomalous traffic and/or notify the user in various examples, thereby protecting the user's Internet-connected devices 124-132 from malicious network traffic.

The recurrent neural network as developed at 116 and installed on the firewall/gateway 122 in this example is trained in a network traffic anomaly server 102 before being distributed to the user's firewall/gateway, but in other examples continues to learn once installed on the firewall/gateway 122 to recognize network traffic that is typical for the particular network environment in which it is installed. In a still further example, the training data 118 that the network traffic anomaly server uses to train the recurrent neural network 116 is specific to the local area network served by firewall/gateway 122, such as traffic data provided by the firewall/gateway to the network traffic anomaly server. In an alternate example, network traffic typical of the type of network in which the firewall/gateway is installed is used to train the recurrent neural network, and in alternate further examples the firewall/gateway is or is not further operable to further train the provided recurrent neural network based on locally-observed network traffic. In a still further example, the trained recurrent neural network is deployed on a remote server and used as a cloud service, such as deployed on server 102 as a cloud service to devices attached to firewall/gateway 122.

The network traffic processed in the recurrent neural network in this example is broken into time segments, such as hourly, daily, or other such segment, and is evaluated by preprocessing the data into a high-dimensional space reflecting various characteristics of the data such as the number of a particular type of network event per hour, type of device to which network traffic is destined, or protocol or port number to which the network traffic is being sent. In a further example, the high-dimensional space further includes time-based information such as day of the week or hour of the day during which traffic is observed. In this example, many tens to hundreds of such features are analyzed and comprise different input dimensions provided to the recurrent neural network from the preprocessor.

The preprocessed high-dimensional data is provided to the recurrent neural network in a time series, such as an input window having a certain length or window history of data. The recurrent neural network process the data in a manner that uses both prior state data and current state data to predict the next data likely to be observed on the network, and in training compares the actual next data with the predicted next data and adjusts the network parameters based on the difference between actual and predicted next data (or the loss) to learn to more accurately predict the next network data. As this learning process is repeated over large volumes of training data, the recurrent neural network learns to more accurately predict the next network data from a sequence of network data. After training, the same recurrent neural network is able to recognize when anomalies occur in network data such as where the difference between predicted and actual network data are significantly larger than might typically be expected. Detection of anomalies in a more detailed example use a difference threshold, z-score, dynamic threshold, differences between short-term and long-term prediction error, or other such methods or combinations of such methods.

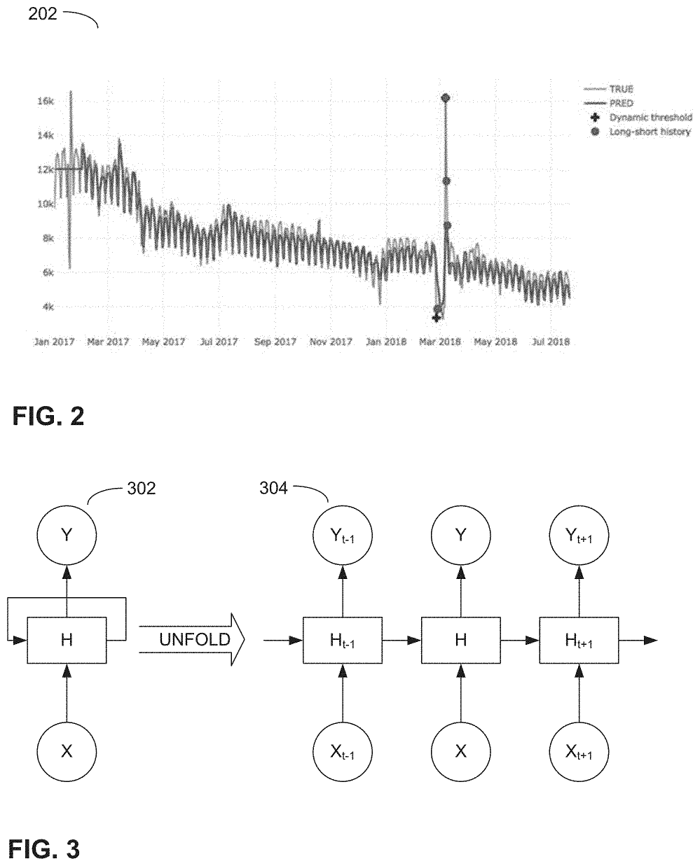

FIG. 2 is a chart showing use of a trained recurrent neural network to identify network traffic anomalies, consistent with an example embodiment. Here, the predicted occurrence of an event, such as login attempts per day or other such event characterized by the high-dimensional preprocessing of the network data, is charted. The bottom line, and generally darker and more compact line, shows predicted number of events based on prior data used to train the recurrent neural network, while the lighter line with greater variance shows the actual observed number of events. In March 2018, a data anomaly occurred, such as where a malicious user might generate a significantly higher number of login attempts than would usually be seen, resulting in a true observed number of events that deviates significantly from the predicted number of events. This deviation or difference is observed as an anomaly in network data traffic, and can be used to indicate potentially malicious network data to a user or network administrator.

In one example, a simple threshold difference between the expected next network traffic data and the observed next network traffic data, either numeric difference or percentage difference, is used to determine whether a network traffic anomaly is present. In other examples, statistical methods such as z-score evaluation or other variance metrics are used to determine the degree of variance from the expected score. Similarly, some examples use dynamic thresholds, allowing the threshold for detecting an anomaly to vary depending on different observed degrees of variance in normal network traffic, or use differences between short-term and long-term prediction errors to identify anomalies.

FIG. 3 shows a recurrent neural network, as may be used to practice some embodiments. Here, a recurrent neural network having sequential inputs X and generating sequential outputs Y is shown at 302, where H is the recurrent neural network function that uses both prior state data and the input X to produce the output Y. There are many variations of input formats X, output formats Y, and network node formats and configurations H that will work to generate a useful result in different example embodiments. In the example of FIG. 3, the recurrent neural network is also shown unfolded over time at 304, reflecting how information from the neural network state at H used to produce output Y from input X is retained and used with the subsequent input Xₜ₊₁ to produce the subsequent output Yₜ₊₁. The outputs Y over time are therefore dependent not only on the current inputs at each point in the sequence, but also on the state of the neural network up to that point in the sequence. This property makes the neural network a recurrent neural network, and makes it well-suited to evaluate input date where sequence and order is important, such as natural language processing (NLP).

In a more detailed example, the recurrent neural network of FIG. 3 can be used to evaluate a network data stream for anomalies, outputting a result at each step predicting the next network data element. Similarly, the recurrent neural network of FIG. 3 can be trained by providing the known next network data element from a training set of data as the desired output Yₜ₊₁, with the difference between observed and expected outputs output Yₜ₊₁ provided as an error signal via backpropagation to train the recurrent neural network to produce the desired output.

In a further example, training is achieved using a loss function that represents the error between the produced output and the desired or expected output, with the loss function output provided to the recurrent neural network nodes at Hₜ and earlier via backpropagation. The backpropagated loss function signal is used within the neural network at Hₜ, Hₜ₋₁, Hₜ₋₂, etc. to train or modify coefficients of the recurrent neural network to produce the desired output, but with consideration of the training already achieved using previous training epochs or data sets. Many algorithms and methods for doing so are available, and will produce useful results here. In operation, the difference between the output of the neural network and the next network data element is compared against a threshold to determine whether the observed next network data element is anomalous and potentially malicious, where the threshold is selected to provide an acceptable false positive rate

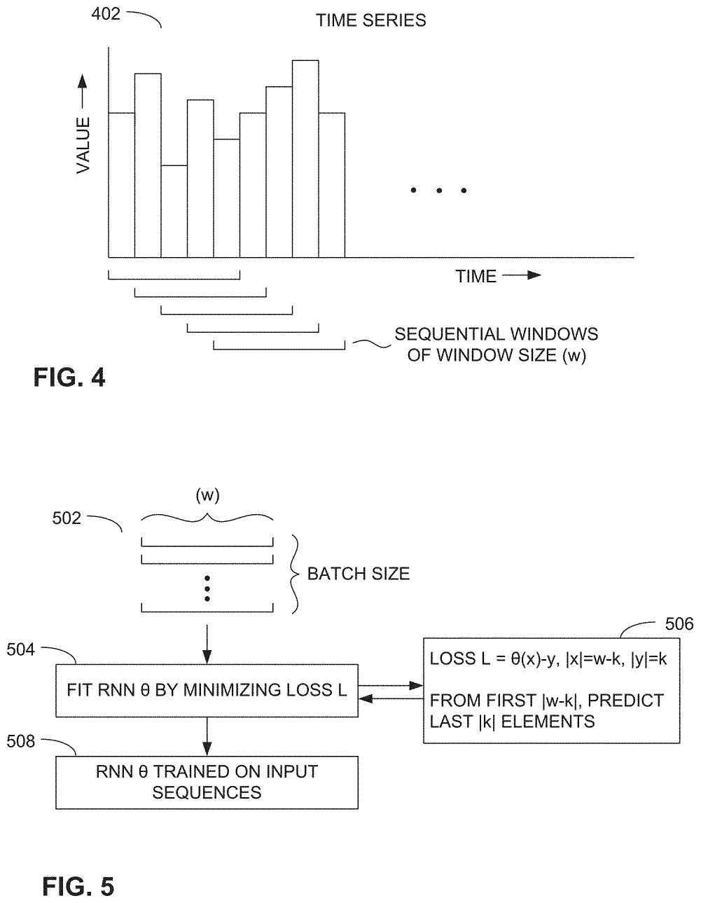

FIG. 4 is a chart showing preprocessed data sequences provided to the recurrent neural network, consistent with an example embodiment. The chart shows generally at 402 a variety of input values of preprocessed network traffic data, such as login attempts per hour, over time. The input values are further grouped into windowed segments of size (w), with sequential segments in this example overlapping significantly as sequential windows advance by one additional input record. Each window comprises a different set of inputs to the recurrent neural network, whether training the neural network or using a trained neural network to evaluate a network data stream for anomalies.

In the example of FIG. 4, the window size for the one-dimensional input shown is five records, such as five hours of previous login attempts per hour, but in many other examples will be longer, such as a day, week, or months' worth of login attempts per hour. These overlapping sequences are extracted are therefore each the same size, extracted from the time series of observed network data. In many such examples, some or many additional dimensions of input data will also be processed, such as other characteristics of network traffic including source, destination, protocol, packet content, and the like.

These windowed time series of data are provided to the network during training with the knowledge of the next element in the data series outside the input window, which is used to train the recurrent neural network to predict the next data element. In operation, the windowed data is provided as an input to the recurrent neural network to generate a predicted output, which is subsequently compared to the actual output such that a difference between the predicted output and observed actual output is used to indicate whether the network data traffic is anomalous or normal.

FIG. 5 shows how sequential input windows are used to train the recurrent neural network, consistent with an example embodiment. Here, input sequences (x) of size (w) are shown at 502, derived from a time sequence of preprocessed data as shown in FIG. 4. A set of input sequences comprise a training batch, with a batch size of the number of input sequence windows as shown at 502. The training batch of windowed, preprocessed network data is then used to fit the recurrent neural network by minimizing loss as previously described, such as by using backpropagation and a loss function to change coefficients of the recurrent neural network to reduce the loss observed between the neural network's output and the actual next data element in the sequence. This is achieved by providing each windowed sequence (w) as an input to the recurrent neural network, which tries to predict the next (k) values from the set of input values (x) or (w−k) as shown at 506. A loss L is computed based on the difference between the next (k) values and the neural network's output θ(x), and used to adjust the weights of the recurrent neural network's nodes to better predict outputs. This process is repeated for all input sequences in a training batch, and in a further example for multiple training batches, until acceptable prediction results are achieved and the recurrent neural network output is trained at 508.

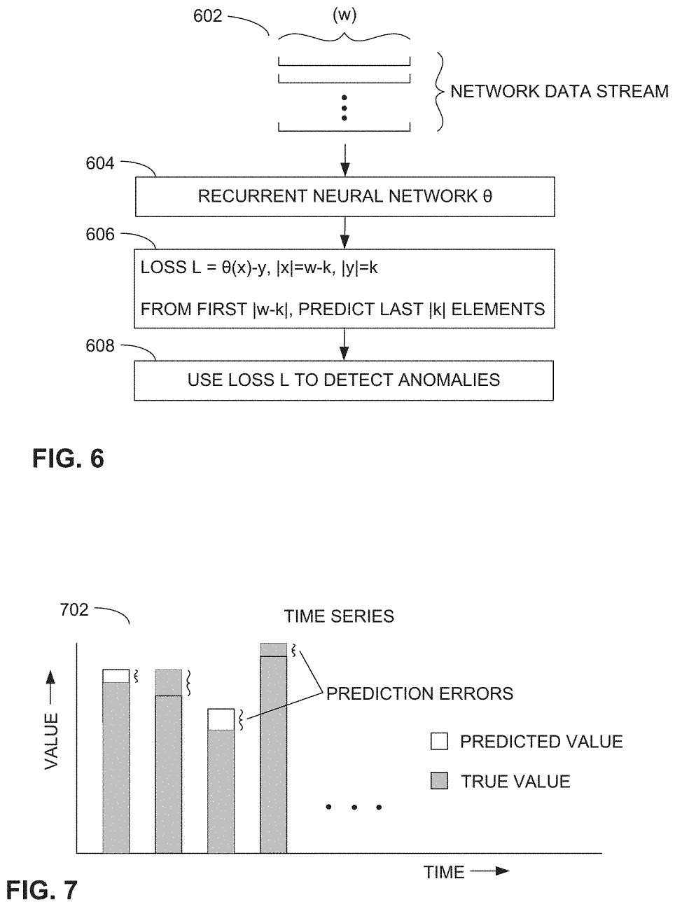

FIG. 6 is a flowchart showing use of a trained recurrent neural network to detect network traffic anomalies, consistent with an example embodiment. Here, windowed input sequences (x) of size (w) are again provided from the network data stream at 602 to the recurrent neural network inputs, and the recurrent neural network generates an output θ(x) at 604. The output is compared to the actual observed next element or elements (k) in the network data sequence at 606, and a loss function L is calculated reflecting the difference between the next (k) values and the neural network's output θ(x). The loss L, or difference, is used along with statistical methods such as a threshold or z-score to determine whether an anomaly has been detected at 608.

FIG. 7 is a graph showing prediction errors or loss L between recurrent neural network output θ(x) and observed next network traffic values (k), consistent with an example embodiment. As shown generally at 702, preprocessed network data values observed over time are also predicted by the recurrent neural network based on prior observed network data values, and the difference is observed as a loss L or prediction error. The white bars in the graph represent the recurrent neural network's predicted values θ(x), derived from prior observed network traffic values (x) input to the recurrent neural network. The gray bars in the graph represent the true, observed next network traffic data (k), and the difference between the predicted values θ(x) and the observed next network traffic data (k) is the prediction error or loss L.

The size of this prediction error or loss L is used to determine whether the observed network traffic (k) deviates sufficiently from the predicted network traffic values θ(x) to be considered a network traffic anomaly, such as by determining whether the prediction error exceeds an absolute threshold, determining whether the prediction error exceeds a threshold determined relative to either the predicted or true network traffic data value, or determining whether the prediction error meets other statistical criteria such as exceeding a z-score or deviation from expected variation between the predicted and true, observed network traffic values. When the prediction error exceeds the threshold or statistical criteria, it is considered an anomaly and is flagged for reporting such as to a network user or administrator.

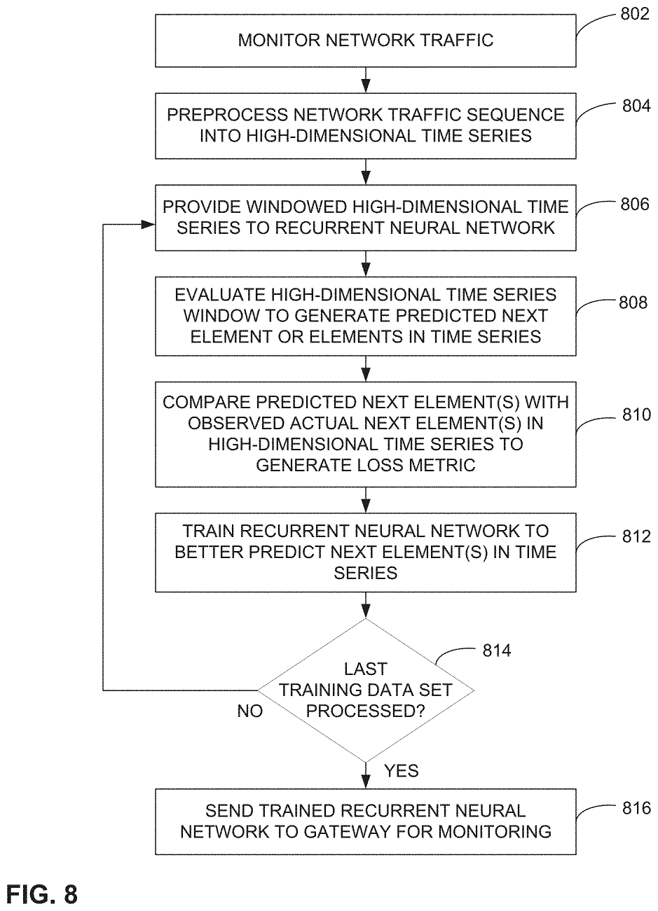

FIG. 8 is a flowchart of a method of training a recurrent neural network to identify anomalies in network traffic, consistent with an example embodiment. Here, network traffic is monitored, such as via a gateway or firewall device, at 802. The network traffic is processed into a high-dimensional time series at 804, such as by quantifying characteristics of the network traffic that may be relevant to characterizing the network traffic for purposes of determining whether the traffic is normal or may include anomalies that indicate threats to the network. In a more detailed example, dimensions include a statistically large number of different metrics, such as more than 20, 30, 50, or 100 such metrics. Examples of metrics include counting the number of various types of network events, such as pings, login requests, or packets using various ports or protocols, and monitoring network packets for type of content, such as video, executable code, or web browser content.

At 806, the high-dimensional time series is windowed, such as by taking sequential overlapping groups of the time series, incremented by a time over which patterns are likely to repeat such as a day or a week, and provided to the recurrent neural network for training. The time series window is evaluated at 808 to generate or output a predicted next element or elements in the series, and the prediction is compared at 810 with the actual, known next elements in the high-dimensional time series to generate a loss metric reflecting the difference. The difference or loss function is fed back into the recurrent neural network, such as through backpropagation or other such methods, and used to alter the neural network coefficients to cause the predicted next element to more closely match the actual or observed next element in the time series, thereby training the neural network to more accurately predict the next element or elements.

This process repeats at 814 for additional windows of training data within the training data batch until the entire training data batch has been processed, at which point the trained recurrent neural network is implemented in the network gateway, firewall, or other such device at 816 where it can be used to monitor the network data traffic flow for anomalies.

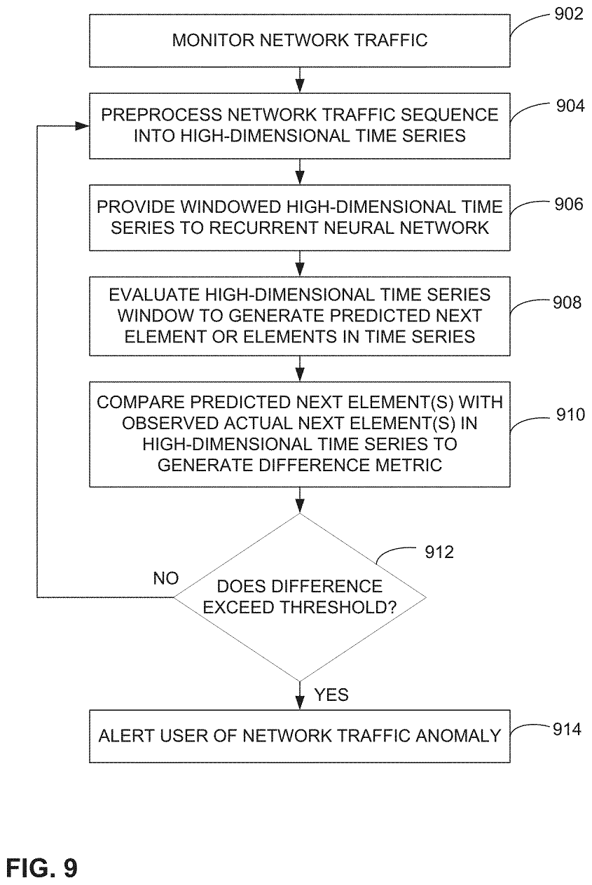

FIG. 9 is a flowchart of a method of using a trained recurrent neural network to identify anomalies in network traffic, consistent with an example embodiment. Here, network traffic is monitored at 902, such as in a router, gateway, firewall, or other device positioned within the network to see traffic destined for a network of interest, such as a corporate local area network. The network traffic is processed into a high-dimensional time series at 904 and provided to a recurrent neural network at 906, much as in the example of FIG. 8. At 908, the high-dimensional time series windowed input is evaluated to generate an output of a predicted next element or elements in the series. At 910, the predicted next element(s) output from the recurrent neural network are compared with the actual next element(s), and a difference metric is generated.

The difference metric is in various further examples compared against an absolute threshold, compared against a threshold determined relative to either the predicted or true network traffic data value, or evaluated using other statistical criteria such as exceeding a z-score or deviation from expected variation between the predicted and true, observed network traffic values. In a further example, the threshold is computed based on a long history, such as the last 100 or more events, to more accurately characterize traffic typical of the network. When the prediction error exceeds the threshold or statistical criteria at 912, it is considered an anomaly and is flagged for reporting such as to a network user or administrator at 914.

In the examples provided herein, a firewall/gateway 122 implements a trained recurrent neural network to detect anomalies in network traffic, and the recurrent neural network is trained in a network anomaly server 102. In a further example, the recurrent neural network is trained specific to the local area network protected by firewall/gateway 122, such as by providing network traffic statistics, either raw or preprocessed, to the network traffic anomaly server 102 as training data. In another example, the

Although the network traffic anomaly server 102 and the firewall/gateway 122 use a recurrent neural network in the examples herein, other examples will use a convolutional neural network or other neural network or artificial intelligence method to evaluate both prior and current inputs in a series of high-dimensional network traffic characteristics to predict one or more next elements in the series. The computerized systems such as the network traffic anomaly server 102 of FIG. 1 used to train the recurrent neural network and the firewall/gateway 122 that executes the recurrent neural network to protect against malicious programs or applications can take many forms, and are configured in various embodiments to perform the various functions described herein.

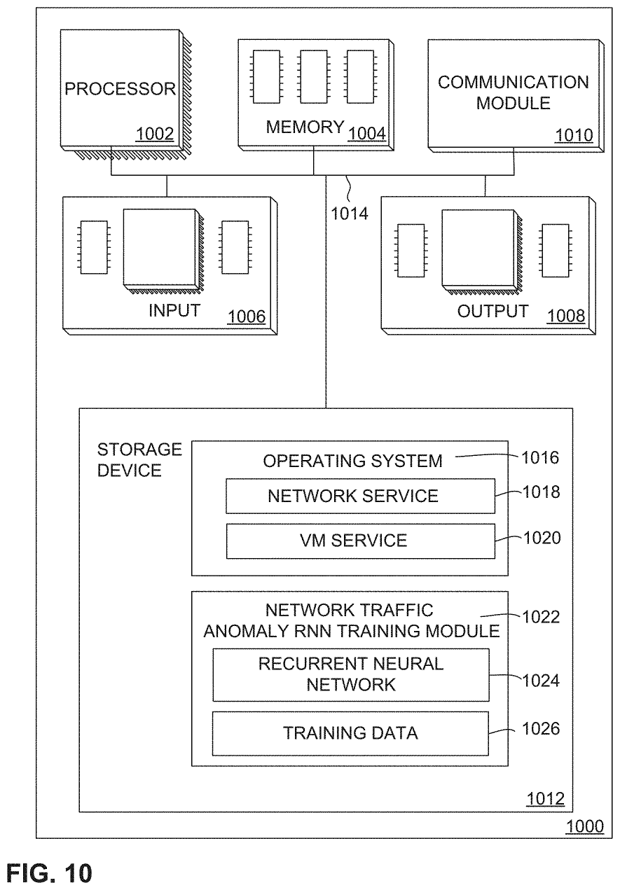

FIG. 10 is a computerized network traffic anomaly system comprising a recurrent neural network training module, consistent with an example embodiment of the invention. FIG. 10 illustrates only one particular example of computing device 1000, and other computing devices 1000 may be used in other embodiments. Although computing device 1000 is shown as a standalone computing device, computing device 1000 may be any component or system that includes one or more processors or another suitable computing environment for executing software instructions in other examples, and need not include all of the elements shown here.

As shown in the specific example of FIG. 10, computing device 1000 includes one or more processors 1002, memory 1004, one or more input devices 1006, one or more output devices 1008, one or more communication modules 1010, and one or more storage devices 1012. Computing device 1000, in one example, further includes an operating system 1016 executable by computing device 1000. The operating system includes in various examples services such as a network service 1018 and a virtual machine service 1020 such as a virtual server. One or more applications, such as network traffic anomaly training module 1022 are also stored on storage device 1012, and are executable by computing device 1000.

Each of components 1002, 1004, 1006, 1008, 1010, and 1012 may be interconnected (physically, communicatively, and/or operatively) for inter-component communications, such as via one or more communications channels 1014. In some examples, communication channels 1014 include a system bus, network connection, inter-processor communication network, or any other channel for communicating data. Applications such as malware evaluation module 1022 and operating system 1016 may also communicate information with one another as well as with other components in computing device 1000.

Processors 1002, in one example, are configured to implement functionality and/or process instructions for execution within computing device 1000. For example, processors 1002 may be capable of processing instructions stored in storage device 1012 or memory 1004. Examples of processors 1002 include any one or more of a microprocessor, a controller, a digital signal processor (DSP), an application specific integrated circuit (ASIC), a field-programmable gate array (FPGA), or similar discrete or integrated logic circuitry.

One or more storage devices 1012 may be configured to store information within computing device 1000 during operation. Storage device 1012, in some examples, is known as a computer-readable storage medium. In some examples, storage device 1012 comprises temporary memory, meaning that a primary purpose of storage device 1012 is not long-term storage. Storage device 1012 in some examples is a volatile memory, meaning that storage device 1012 does not maintain stored contents when computing device 1000 is turned off In other examples, data is loaded from storage device 1012 into memory 1004 during operation. Examples of volatile memories include random access memories (RAM), dynamic random access memories (DRAM), static random access memories (SRAM), and other forms of volatile memories known in the art. In some examples, storage device 1012 is used to store program instructions for execution by processors 1002. Storage device 1012 and memory 1004, in various examples, are used by software or applications running on computing device 1000 such as network traffic anomaly RNN training module 1022 to temporarily store information during program execution.

Storage device 1012, in some examples, includes one or more computer-readable storage media that may be configured to store larger amounts of information than volatile memory. Storage device 1012 may further be configured for long-term storage of information. In some examples, storage devices 1012 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 1000, in some examples, also includes one or more communication modules 1010. Computing device 1000 in one example uses communication module 1010 to communicate with external devices via one or more networks, such as one or more wireless networks. Communication module 1010 may be a network interface card, such as an Ethernet card, an optical transceiver, a radio frequency transceiver, or any other type of device that can send and/or receive information. Other examples of such network interfaces include Bluetooth, 4G, LTE, 5G, WiFi, Near-Field Communications (NFC), and Universal Serial Bus (USB). In some examples, computing device 1000 uses communication module 1010 to wirelessly communicate with an external device such as via public network 120 of FIG. 1.

Computing device 1000 also includes in one example one or more input devices 1006. Input device 1006, in some examples, is configured to receive input from a user through tactile, audio, or video input. Examples of input device 1006 include a touchscreen display, a mouse, a keyboard, a voice responsive system, video camera, microphone or any other type of device for detecting input from a user.

One or more output devices 1008 may also be included in computing device 1000. Output device 1008, in some examples, is configured to provide output to a user using tactile, audio, or video stimuli. Output device 1008, in one example, includes a display, a sound card, a video graphics adapter card, or any other type of device for converting a signal into an appropriate form understandable to humans or machines. Additional examples of output device 1008 include a speaker, a light-emitting diode (LED) display, a liquid crystal display (LCD), or any other type of device that can generate output to a user.

Computing device 1000 may include operating system 1016. Operating system 1016, in some examples, controls the operation of components of computing device 1000, and provides an interface from various applications such as network traffic anomaly RNN training module 1022 to components of computing device 1000. For example, operating system 1016, in one example, facilitates the communication of various applications such as network traffic anomaly RNN training module 1022 with processors 1002, communication unit 1010, storage device 1012, input device 1006, and output device 1008. Applications such as network traffic anomaly RNN training module 1022 may include program instructions and/or data that are executable by computing device 1000. As one example, network traffic anomaly RNN training module 1022 evaluates training data 1026 using recurrent neural network 1024, such that the recurrent neural network when trained is operable to detect anomalies in network traffic data. These and other program instructions or modules may include instructions that cause computing device 1000 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of identifying anomalous traffic in a sequence of computer network traffic, comprising:
preprocessing the sequence of computer network traffic into a high-dimensional time series sequence of computer network traffic;
providing the high-dimensional time series to a recurrent neural network;
evaluating the provided high-dimensional time series in the recurrent neural network to generate and output a predicted next element in the high-dimensional time series;
comparing the predicted next element in the high-dimensional time series with an observed actual next element in the high-dimensional time series; and
determining whether the observed next element in the high-dimensional time series is anomalous based on a difference between the predicted next element in the high-dimensional time series with an observed actual next element in the high-dimensional time series.

2. The method of identifying anomalous traffic in a sequence of computer network traffic of claim 1, wherein the recurrent neural network is configured to provide an output based on both the current input and at least one prior input in the sequence previously provided to the recurrent neural network.

3. The method of identifying anomalous traffic in a sequence of computer network traffic of claim 1, wherein the high-dimensional time series comprises 30 or more features of the sequence of computer network traffic derived from the sequence of computer network traffic during preprocessing.

4. The method of identifying anomalous traffic in a sequence of computer network traffic of claim 1, wherein the recurrent neural network is trained on windowed sequences from the sequence of computer network traffic.

5. The method of identifying anomalous traffic in a sequence of computer network traffic of claim 4, wherein the window comprises a multiple of a day or a week.

6. The method of identifying anomalous traffic in a sequence of computer network traffic of claim 1, wherein the difference between the predicted next element in the high-dimensional time series and an observed actual next element in the high-dimensional time series comprise at least one of absolute difference, difference relative to either predicted or actual observed next element, z-score, dynamic threshold, or difference between short-term and long-term prediction error.

7. The method of identifying anomalous traffic in a sequence of computer network traffic of claim 1, further comprising notifying a user upon determination that the observed next element in the high-dimensional time series is anomalous

8. The method of identifying anomalous traffic in a sequence of computer network traffic of claim 1, wherein the recurrent neural network is trained in a remote server based on network data from a local firewall/gateway.

9. A computer network gateway configured to detect anomalous traffic in a sequence of computer network traffic, comprising:
a processor operable to execute a series of computer instructions; and
a set of computer instructions comprising a preprocessor module, a recurrent neural network module, and an output module;
the preprocessor module operable to process the sequence of computer network traffic into a high-dimensional time series sequence of computer network traffic;
the recurrent neural network module operable to receive the high-dimensional time series from the preprocessor and to evaluate the provided high-dimensional time series to generate and output a predicted next element in the high-dimensional time series; and
the output module operable to compare the predicted next element in the high-dimensional time series with an observed actual next element in the high-dimensional time series, and to determine whether the observed next element in the high-dimensional time series is anomalous based on a difference between the predicted next element in the high-dimensional time series with an observed actual next element in the high-dimensional time series.

10. The computer network gateway of claim 9, wherein the recurrent neural network module is configured to provide the output based on both the current input and at least one prior input in the sequence previously provided to the recurrent neural network.

11. The computer network gateway of claim 9, wherein the high-dimensional time series comprises 30 or more features of the sequence of computer network traffic derived from the sequence of computer network traffic during preprocessing.

12. The computer network gateway of claim 9, wherein the recurrent neural network is trained on windowed sequences from the sequence of computer network traffic.

13. The computer network gateway of claim 12, wherein the window comprises a multiple of a day or a week.

14. The computer network gateway of claim 9, wherein the difference between the predicted next element in the high-dimensional time series and an observed actual next element in the high-dimensional time series comprise at least one of absolute difference, difference relative to either predicted or actual observed next element, z-score, dynamic threshold, or difference between short-term and long-term prediction error.

15. The computer network gateway of claim 9, the output module further operable to notify a user upon determination that the observed next element in the high-dimensional time series is anomalous

16. The computer network gateway of claim 9, wherein the recurrent neural network is trained in a remote server based on network data provided from the gateway.

17. The computer network gateway of claim 16, wherein the network data provided from the gateway comprises network data the preprocessor module has processed into a high-dimensional time series sequence of computer network traffic.

18. A method of training a recurrent neural network to identify anomalous traffic in a sequence of computer network traffic, comprising:
preprocessing the sequence of computer network traffic into a high-dimensional time series sequence of computer network traffic;
providing the high-dimensional time series to a recurrent neural network;
evaluating the provided high-dimensional time series in the recurrent neural network to generate and output a predicted next element in the high-dimensional time series;
comparing the predicted next element in the high-dimensional time series with an observed actual next element in the high-dimensional time series to generate a loss metric; and
training the recurrent neural network to better predict the next element using the loss metric by adjusting coefficients of the recurrent neural network to reduce the loss metric.

19. The method of training a recurrent neural network of claim 18, further comprising repeating the preprocessing, providing, evaluating, comparing, and training steps for a series of sequential windowed data sets derived from the computer network traffic.

20. The method of training a recurrent neural network of claim 18, further comprising receiving computer network traffic information from a remote gateway for use in training the recurrent neural network to identify anomalous traffic in the remote gateway, and sending the trained recurrent neural network to the remote gateway after training.
